(19) United States
(12) Patent Application Publication
(10) Pub. No.: US 2008/0205967 A1
(43) Pub. Date: Aug. 28, 2008

(54) Writing Instrument Attachment System

(76) Inventor: Ross Purvine, Beverly Hills, CA (US)

Correspondence Address: PATWRITE LLC, 408 W. MAIN ST., MARSHALLTOWN, IA, 50158-5759, US

(21) Appl. No.: 12/037,796

(22) Filed: Feb. 26, 2008

Related U.S. Application Data
(60) Provisional application No. 60/903,333, filed on Feb. 26, 2007.
(60) Provisional application No. 60/959,621, filed on Jul. 16, 2007.

(51) Int. Cl. B43K 24/00; B23P 11/00

(52) U.S. Cl. 401/131; 29/428

(57) ABSTRACT

A writing instrument attachment system comprises a writing instrument holder base with a restraining connector secured with at least one zip tie and a writing instrument secured to the other end of the restraining connector using at least another zip tie. In one embodiment, a writing instrument connector is secured to an end of the writing instrument using a gasket and then slipping an eye zip tie over the gasket; then tightening the zip tie. Another embodiment utilizes a writing instrument that has an eye attached therein. In this embodiment, the other end of the restraining connector is inserted in the writing instrument eye and then secured with a zip tie. In another embodiment, a broken restraining connector is reused by forming a loop and securing the loop with at least one zip tie and then using the loop to secure the writing instrument without replacing the original base.

### RELATED APPLICATIONS

This application claims priority and herein incorporates by reference U.S. Provisional Application Ser. No. 60/903,333, filed on Feb. 26, 2007, and 60/959,621, filed on Jul. 16, 2007, the complete disclosures of each of which are hereby incorporated by reference.

### BACKGROUND OF THE INVENTION

Since the time of cave paintings, humans have been using written communication to record their thoughts, exploits, fears and many other things from the trivial to the Code of Hammurabi. One common element linking all these is the need to use a writing instrument. In modern times, the need to use a writing instrument such as a pen is pervasive especially with the advent of checks and credit cards. Often, a person needs to use a pen, yet may not have one. Merchants often provide a pen for the use of employees and customers; however, either accidentally or on purpose, these courtesy pens often come up missing.

It is known to secure pens to a base that has a chain, cable or other restraining system. While this helps keep the pen in place, the pen eventually needs to be replaced and sometimes the restraining system fails leaving a base with no pen. Often, a new base with pen is provided leaving the remains of the old system which is unsightly and more expensive since a completely new unit must be purchased.

There is a need for a writing instrument attachment system that overcomes the limitations of the prior art.

### SUMMARY OF THE INVENTION

A writing instrument attachment system comprises a writing instrument holder base with a restraining connector secured with at least one zip tie and a writing instrument secured to the other end of the restraining connector using at least another zip tie. In one embodiment, a writing instrument connector is secured to an end of the writing instrument using a gasket and then slipping an eye zip tie over the gasket; then tightening the zip tie. Another embodiment utilizes a writing instrument that has an eye attached therein. In this embodiment, the other end of the restraining connector is inserted in the writing instrument eye and then secured with a zip tie. In another embodiment, a broken restraining connector is reused by forming a loop and securing the loop with at least one zip tie and then using the loop to secure the writing instrument without replacing the original base.

Other features and advantages of the instant invention will become apparent from the following description of the invention which refers to the accompanying drawings.

### BRIEF DESCRIPTION OF THE DRAWINGS

FIG. 1 is a perspective drawing of a writing instrument secured using the writing instrument attachment system according to an embodiment of the present invention.

FIG. 2 is a perspective drawing of a writing instrument secured using the writing instrument attachment system according to an embodiment of the present invention.

FIG. 3 is a perspective drawing of a writing instrument secured using the writing instrument attachment system according to an embodiment of the present invention.

FIG. 4 is a perspective drawing of a writing instrument secured using the writing instrument attachment system according to an embodiment of the present invention.

FIG. 5 is a close-up view of an embodiment of a restraining connector connected to a typical base according to an embodiment of the present invention.

FIG. 6 is a close-up view of an embodiment of a restraining connector connected to a typical base according to an embodiment of the present invention.

FIG. 7 is a perspective drawing of a writing instrument secured using the writing instrument attachment system according to an embodiment of the present invention.

FIG. 8A is perspective drawing of a step according to an embodiment of the present invention.

FIG. 8B is perspective drawing of another step according to an embodiment of the present invention.

FIG. 8C is perspective drawing of another step according to an embodiment of the present invention.

FIG. 8D is perspective drawing of another step according to an embodiment of the present invention.

FIG. 9 is a perspective drawing of a writing instrument according to an embodiment of the present invention.

FIG. 10 is a perspective drawing of a writing instrument according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

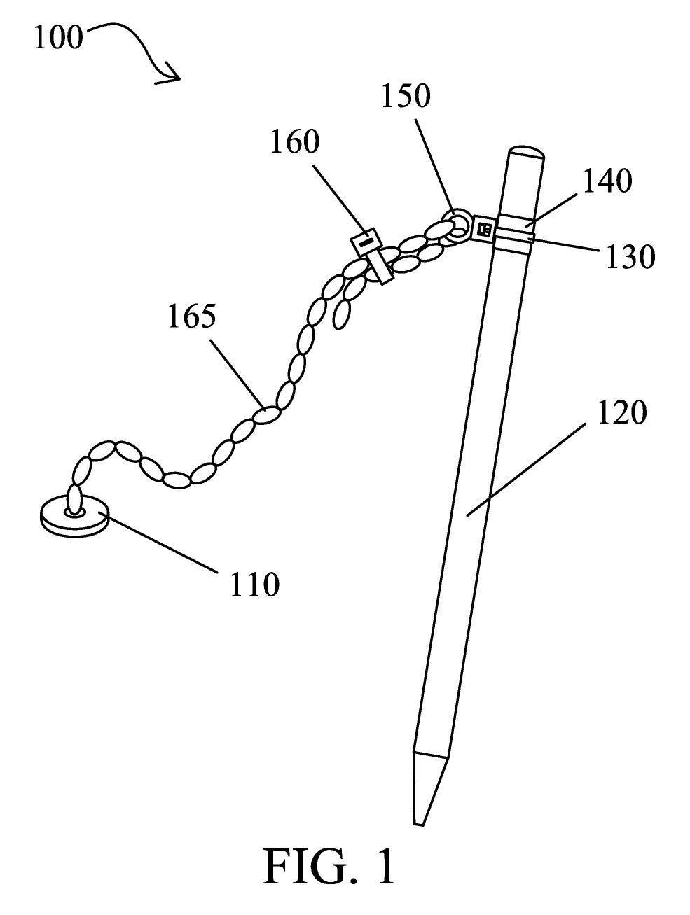

Referring to FIG. 1, a writing instrument attachment system 100 comprises a base 110 with an attached restraining connector 165 disposed therein. A gasket 140 is placed on the non-writing end of writing instrument 120 and then an eye zip tie 130 is placed over gasket 140. Gasket 130 increases the friction between writing instrument 120 and eye zip tie 130 to securely hold eye zip tie therein. Restraining connector 165 is shown as a link chain, however, any suitable securing material may be used such as cable, string, wire as is known in the art. Restraining connector 165 is inserted through an eye 150 disposed on eye zip tie 130 forming a loop. The loop is secured with another zip tie 160 thereby securely holding writing instrument 120 therein. Eye zip tie may be a swivel type that allows writing instrument 120 to rotate without placing a strain on restraining connector 165.

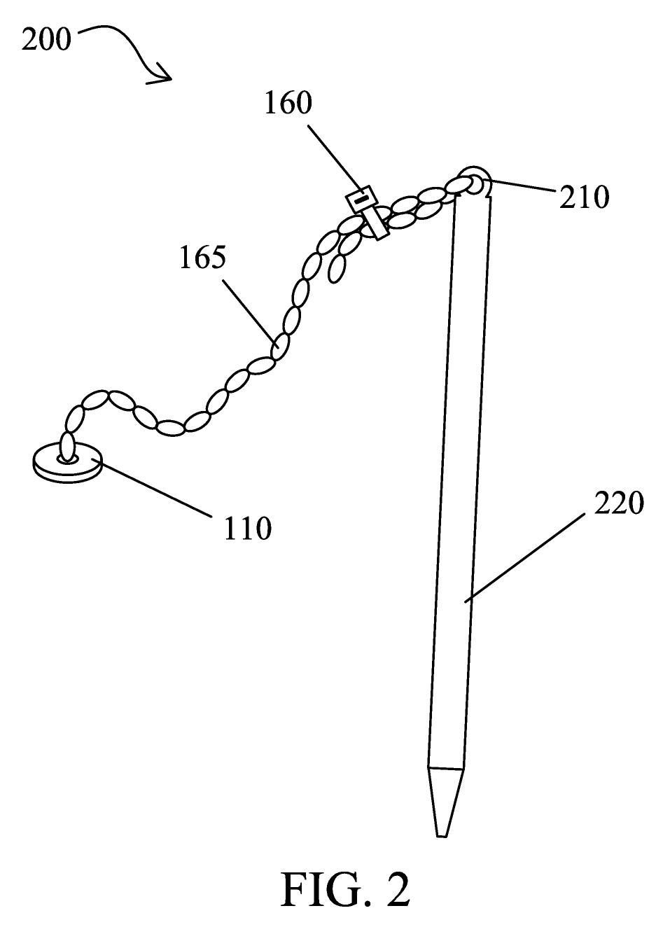

Now referring to FIG. 2, a writing instrument attachment system 200 is shown having base 110, restraining connector 165 and a writing instrument 220. Writing instrument 220 has a loop 210 disposed on an end therein whereby restraining connector 165 is inserted through loop 210 and then secured using zip tie 160.

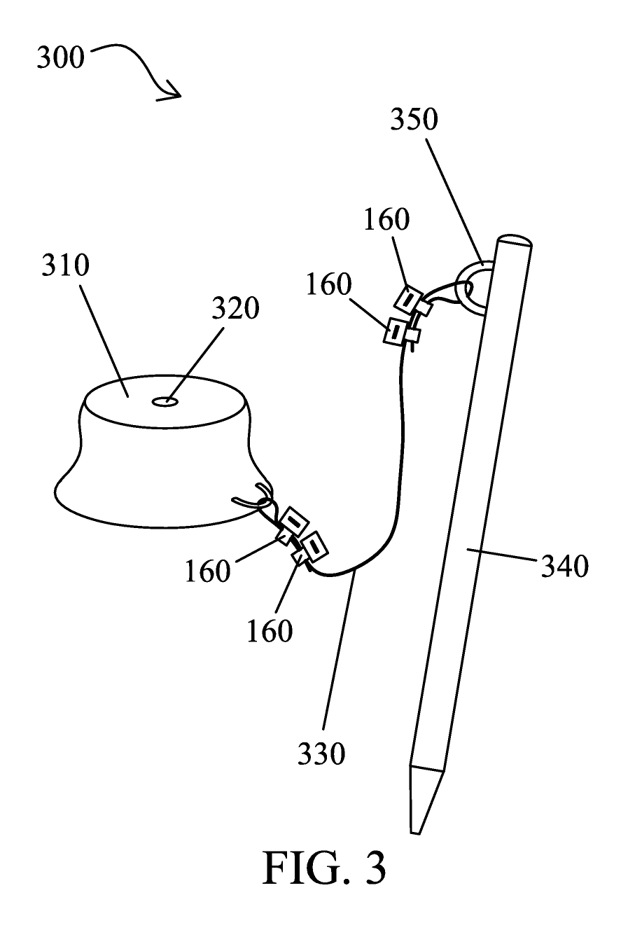

Referring to FIG. 3, a writing instrument attachment system 300 has a base 310 with a hole 320 used to hold a writing instrument 340. Writing instrument 340 has a loop 350 disposed on an end therein. A cable 330 is attached to a base loop using at least one zip tie 160. In the embodiment shown, two zip ties 160 are used. The other end of cable 330 is inserted through writing instrument loop 350 and then secured using at least one zip tie 160. Again, as discussed above, two zip ties 160 are used in this embodiment.

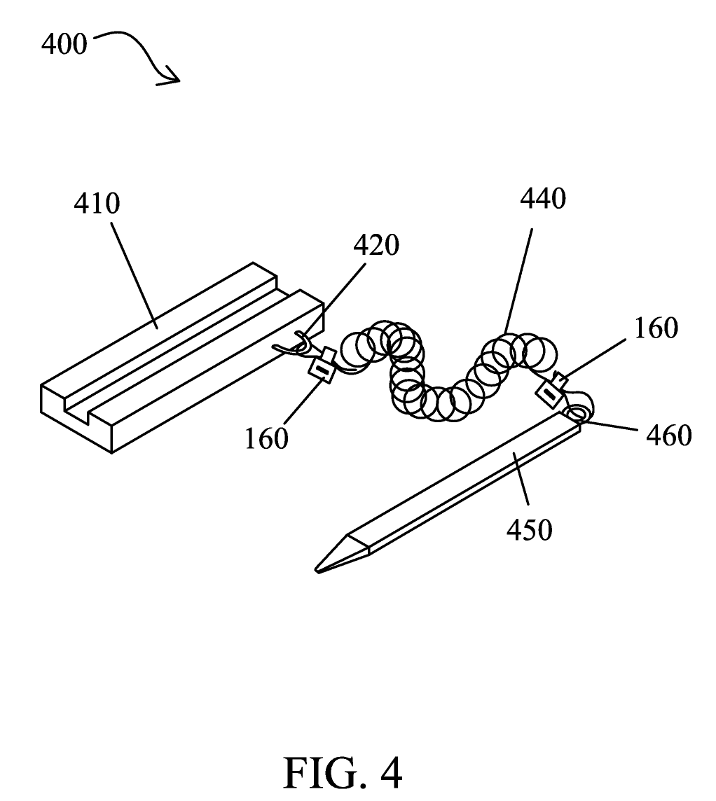

FIG. 4 shows a writing instrument attachment system having a base 410 with a loop 420. A coiled cable 440 is inserted through loop 420 and secured with at least one zip tie 160. The other end of coiled cable 440 is inserted through a loop 460 disposed on an end of a writing instrument 450 and secured with zip tie 160.

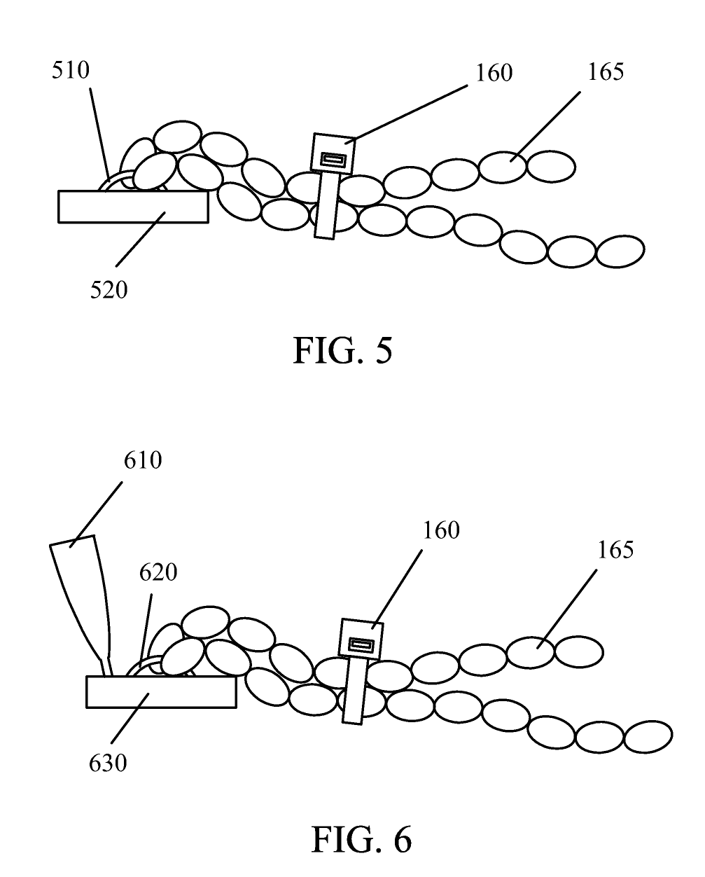

Now referring to FIGS. 5 and 6, different bases 520 and 630 respectively are shown with restraining connector 165 attached to a loop 510 and 620 respectively and then secured using at least one zip tie 160. A pen holding sleeve 610 is attached to base 630 to hold a writing instrument (not shown) as is known in the art.

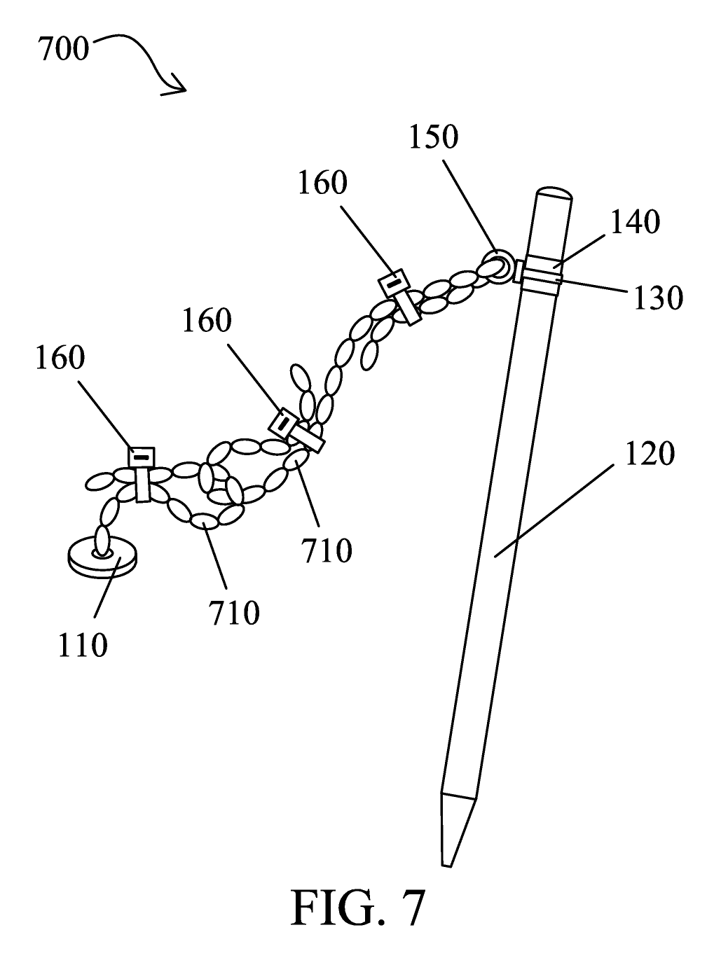

FIG. 7 details a method of using a writing instrument attachment system 700 with an existing base with a broken restraining connector. The broken restraining connector is formed into a loop 710 and secured with zip tie 160. A similar loop 710 is formed on an end portion of the restraining connector attached to writing instrument 120 which is attached as discussed above and the free end passes through loop 710 and then secured using zip tie 160 to join both sections of the restraining connector.

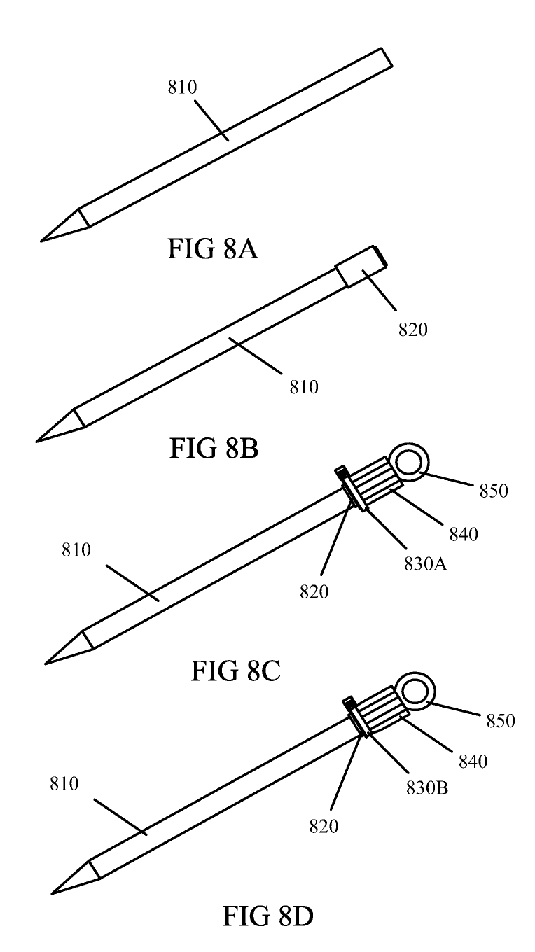

A method of using a writing instrument attachment system is shown in FIGS. 8A-8D and comprises the steps of obtaining a writing instrument 810. Writing instrument 810 may be a pen, pencil or even a computer stylus. A gasket 820 is placed over the end of writing instrument 810 and a vane assembly 840 is placed over gasket 820. Gasket 820 is a rubber like material such as a rubber band or rubber sheet. Other materials such as nylon, cloth, etc. may be used to help secure vane assembly 840 to writing instrument 810. Vane assembly 840 has an eye 850 for attachment to a restraining connector (not shown) as discussed above. A loose zip tie 830A is placed over vane assembly 840 and tightened 830B securing vane assembly 840 to writing instrument 810. Of course other geometries for loop 850 is possible such as being located on a side portion other acceptable securing method. Additionally, zip tie 830 may be provided as a separate component or may be moveably secured to vane assembly 840.

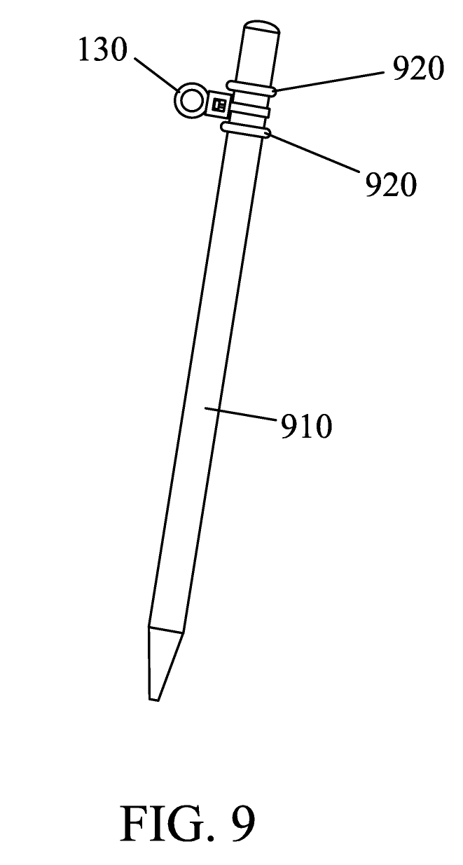

Referring to FIG. 9, a writing instrument 910 is shown having two ridges 920 disposed on an end therein to securely hold eye zip tie 130 without the need for a gasket.

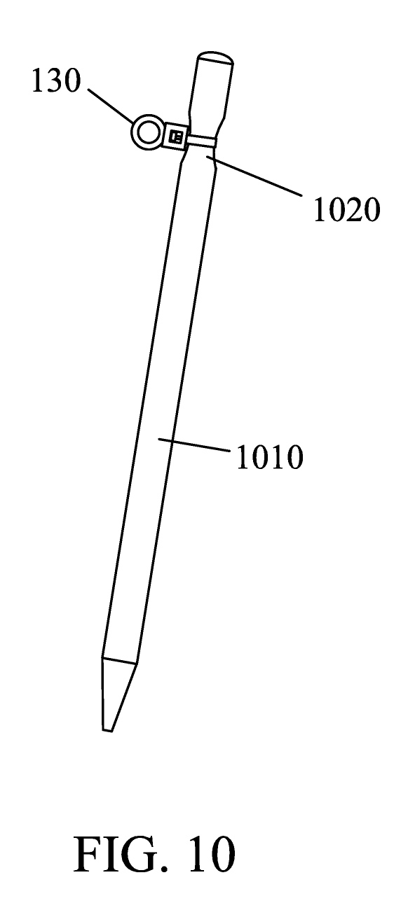

FIG. 10 illustrates an alternative embodiment that does away with the need for a gasket. A writing instrument 1010 is shown having a narrow portion 1020 that securely holds eye zip tie 130.

Although the instant invention has been described in relation to particular embodiments thereof, many other variations and modifications and other uses will become apparent to those skilled in the art.

What is claimed is:

1. A writing instrument attachment system comprises:
a base;
a restraining connector having an instrument end and being connected to said base at another end;
a writing instrument;
a gasket disposed on a non-writing end of said writing instrument;
an eye zip tie disposed over said gasket wherein said eye zip tie is secured to said non-writing end; and
at least another zip tie securing said instrument end to said eye zip tie wherein said writing instrument is secured to said base.

2. A writing instrument attachment system according to claim 1 wherein said restraining connector is connected to said base using at least one other zip connector.

3. A writing instrument attachment system according to claim 1 wherein said restraining connector is a chain.

4. A writing instrument attachment system according to claim 1 wherein said restraining connector is a wire.

5. A writing instrument attachment system according to claim 1 wherein said restraining connector is a cable.

6. A writing instrument attachment system according to claim 1 wherein said restraining connector is a coiled cable.

7. A writing instrument attachment system according to claim 1 wherein said writing instrument has two retaining ridges disposed at said non-writing end wherein said eye zip tie is constrained between said ridges.

8. A writing instrument attachment system according to claim 1 wherein said writing instrument has a narrow portion disposed at said non-writing end wherein said eye zip tie is constrained in said narrow portion.

9. A writing instrument attachment system according to claim 1 wherein said eye zip tie swivels 360 degrees wherein said eye allows said writing instrument to rotate without twisting said restraining connector.

10. A method for attaching a writing instrument to a base comprising the steps of:
obtaining a writing instrument;
sliding a gasket over a non-writing end of said writing instrument;
inserting said gasket into a vane assembly;
sliding a zip tie over said vane assembly;
tightening said zip tie;
attaching an end of a restraining connector to a vane assembly eye; and
securing said end of said restraining connector with at least one other zip tie to said vane assembly eye; and
securing another end of said restraining connector to said base.

11. A method for attaching a writing instrument to a base comprising the steps of:
obtaining a writing instrument;
sliding a gasket over a non-writing end of said writing instrument;
sliding an eye zip tie over said gasket;
tightening said eye zip tie;
inserting an end of a restraining connector through said eye zip tie forming a loop therein;
securing said loop with at least one other zip tie; and
securing another end of said restraining connector to said base.
